(19) United States
(12) Patent Application Publication
(10) Pub. No.: US 2008/0278015 A1
(43) Pub. Date: Nov. 13, 2008

(54) Actuator Having An Electric Actuating Motor And Controllable Friction Clutch Having Such An Actuator

(76) Inventor: Karl Reisinger, Graz (AT)

Correspondence Address: BACHMAN & LAPOINTE, P.C., 900 CHAPEL STREET, SUITE 1201, NEW HAVEN, CT, 06510, US

(21) Appl. No.: 10/578,044

(22) PCT Filed: Oct. 29, 2004
(86) PCT No.: PCT/AT2004/000378

§ 371 Date: Aug. 3, 2008

(51) Int. Cl. H02K 1/00; H02K 7/108

(52) U.S. Cl. 310/152; 310/78

(57) ABSTRACT

An actuator comprises an electric actuating motor, a transmission mechanism and an actuating element, the actuating motor being a DC motor which comprises a first part having permanent magnets and a second part having windings and pole teeth. In order to be able to hold the actuator in any desired, adopted position without any additional apparatuses, the first part (30) has alternately first zones having a low magnetic field strength (31) and second zones having a high field strength (32) over its circumference, the circumferential angle (33) of the second zones (32) being equal to the circumferential angle (38) of the pole teeth (37) of the second part (35), the number of pole teeth (37) being selected such that all of the second zones (32) are always passed at the same time by a pole tooth (37), with the result that, in the event of a rotation in the state in which there is no current flowing, a pulsating torque is exerted between the first part (30) and the second part (35).

### BACKGROUND OF THE INVENTION

The invention relates to an actuator comprising an electric actuating motor, a transmission mechanism and an actuating element, it being possible for the actuating element to be brought into a specific position by the actuating motor being driven and also to be held in this position, and the actuating motor being a DC motor which comprises a first part with a number of permanent magnets distributed over the circumference and a second part which has pole teeth having windings, which are fed with commutated current, and it being possible for one of the two parts to be rotated in relation to the other.

Actuators are used for automation purposes in a wide variety of systems and apparatuses, in particular also for operating gear mechanisms, for actuating controllable clutches, for example in motor vehicles, and also for window winders, seat adjustment devices or the like in motor vehicles. In all of these applications it is necessary to hold the switched position/adjustment even when the switching or adjustment has been executed.

In this regard there are in principle three possibilities: firstly: the transmission mechanism is self-locking, for example a worm gear having a high transmission ratio. However, this considerably impairs the efficiency and requires a larger, more powerful motor. Secondly: a current, a holding current, continues to be applied to the motor, even in the respective position. Although the current is lower, it does result in an increased thermal load on the motor over a relatively long period of time and requires energy. In addition, it needs to be set very precisely. Thirdly: an additional brake, which considerably increases the design complexity and needs to be driven separately. All three possibilities are unsatisfactory, irrespective of the type or design of actuating motor.

DC motors are therefore also used as the actuating motor, said DC motors comprising a first part having a number of permanent magnets distributed over the circumference and a second part, which has pole teeth having windings, which are fed with commutated current. In this case, a DC motor is to be understood in the broader sense; it may be a conventional DC motor with brushes or a brushless DC motor. In the latter case, commutation takes place electronically by means of a suitable feed circuit. The first part may be both the rotor and the stator and expediently has at least two permanent magnets distributed over the circumference. The second part may be both the stator and the rotor, it being possible for the rotor to be inside or outside the stator. The first or second part may also be in the form of a disk, in which case the motor is a so-called disk-rotor machine. However, the first part with the permanent magnets is often the stator and the second part is the inner, cylindrical rotor. Note should be made of the fact that stepper motors are not included here which advance a specific number of steps having a defined angle and need to have a current applied to them for this purpose.

One object of the invention is to propose an actuator which allows for an adopted position to be held in a manner which is as simple as possible without the above disadvantages.

### SUMMARY OF THE INVENTION

The object is achieved according to the invention by the fact that the first part (that is the part with the permanent magnets) has alternately first zones having a low magnetic field strength and second zones having a high magnetic field strength over its circumference, the circumferential angle of the second zones being essentially (i.e. approximately) equal to the circumferential angle of the pole teeth of the second part, and furthermore the number of pole teeth distributed evenly over the circumference being selected such that all of the second zones are always passed at the same time by a pole tooth, with the result that, when the motor rotates in the state in which there is no current flowing, a pulsating torque is exerted between the first part and the second part. In the positions in which this torque is a minimum, in the so-called “magnetic rest positions”, a holding torque takes effect, which attempts to and is suitable for holding the rotatable part of the motor.

Owing to the measures according to the invention, the opposite is achieved from that which is normally intended, namely reducing the braking torque in the currentless state (cogging torque). Owing to the first zones between the permanent magnets, the reluctance of the motor is increased in the currentless state depending on the angle. The reluctance then produces the holding torque, which is particularly severe owing to the measures according to the invention, without any current being applied in the magnetic rest positions—whose location and number depend on the arrangement of permanent magnets and pole teeth. The holding torque becomes so great that it is sufficient, in conjunction with a transmission mechanism which is subject to friction, for holding adopted positions of the actuating element even if the rated torque of the actuator is present at the output drive of the transmission mechanism. It should be emphasized that the actuating motor itself does not remain (like a stepper motor) in a precisely defined position but in the magnetic rest position which is closest to the respective position and is determined by the permanently magnetic field.

The transmission mechanism may be a non-self-locking gear mechanism. The friction which is then less prevalent and the transmission are sufficient, in conjunction with the increased reluctance according to the invention, for holding the position. During actuated operation (i.e. when a current is applied), the actuating motor overcomes, with the aid of its winding, the braking effect exerted by the reluctance and performs the desired actuating movement at its normal speed.

The measures according to the invention can be implemented in a variety of ways: in one first embodiment, the first zones having a low magnetic field strength and the second zones having a high magnetic field strength are produced by the permanent magnet(s) being magnetized variably over the circumference. This particularly simple and inexpensive design is particularly suitable for small actuating motors and mass production.

In one second embodiment, at least some of the first zones having a low magnetic field strength are formed by interspaces between two adjacent permanent magnets. In this case, the pole teeth are distributed evenly over the circumference and there is a certain degree of freedom of design in terms of the number and arrangement of the permanent magnets.

In one third embodiment, at least some of the first zones having a low magnetic field strength are created by the air gap being enlarged in the radial direction in at least individual permanent magnets, whose circumferential angle is a multiple of the circumferential angle of the pole teeth. A lower number of permanent magnets is therefore required which are assigned to a plurality of pole teeth for this purpose. The enlargement of the air gap in the radial direction can be achieved in a variety of ways, preferably by slots incorporated in the permanent magnets.

In order to maximize the reluctance braking according to the invention, at least some of the first zones having a low magnetic field strength cover approximately the same circumferential angle as the interspaces in the circumferential direction between the pole teeth, and this circumferential angle is in the range between 0.2 and 0.3 times the circumferential angle of the pole teeth. As a result, the lines of force of the magnetic field covered by the permanent magnets come to lie such that their braking effect is particularly great.

In a similar manner, a further measure for maximizing the reluctance braking also takes effect. It consists in the thickness of the tips of the pole teeth in the radial direction being smaller than the distance between the tips of two adjacent pole teeth. The tips of the pole teeth are, in cross section, the interspaces between ends which delimit the pole teeth in the circumferential direction. If these tips are thin, only low eddy currents and peripheral currents are induced by the permanently magnetic field.

One particularly simple design which at least differs from the conventional design consists in the fact that the first part is the stator, and the second part is the inner rotor. One particularly advantageous and maintenance-free design is possible when the motor is driven electronically. With such a driving method, the commutation can be implemented electronically. In this design, the second part is the stator, and the first part is the inner rotor. This is possible without extra complexity in terms of hardware if an electronic driving system is provided in any case.

The invention also relates to a controllable friction clutch having an actuator. In the case of friction clutches, the disadvantages of the known actuators mentioned initially are serious and the problem on which the invention is based is particularly relevant. In the case of multiple-disk clutches in the drive train of a motor vehicle, a very rapid response is necessary on top of everything else in specific driving situations (braking with ABS). It has been shown that the actuator according to the invention opens the clutch quickly owing to its rapid response when a corresponding current is applied and, nevertheless, also holds the clutch actually against the action of the clutch spring(s).

In one particularly advantageous embodiment of such a clutch, the transmission mechanism is a toothed gear, and the actuating element comprises two ramp rings which can be rotated in relation to one another, it being possible for at least one to be rotated depending on the arrangement. Such an actuating element is subject to particularly little friction and is particularly sensitive, and the actuator can react very rapidly and with little inertia thanks to the design according to the invention.

### BRIEF DESCRIPTION OF THE DRAWINGS

The invention will be described and explained below with reference to illustrations, in which:

FIG. 1 shows a schematic of a clutch according to the invention,

FIG. 2 shows a cross section according to AB in FIG. 1 through an actuating motor according to the invention, in a first embodiment,

FIG. 3 is as for FIG. 2, in a second embodiment,

FIG. 4 is as for FIG. 2, in a third embodiment, and

FIG. 5 is as for FIG. 2, in a fourth embodiment.

### DETAILED DESCRIPTION

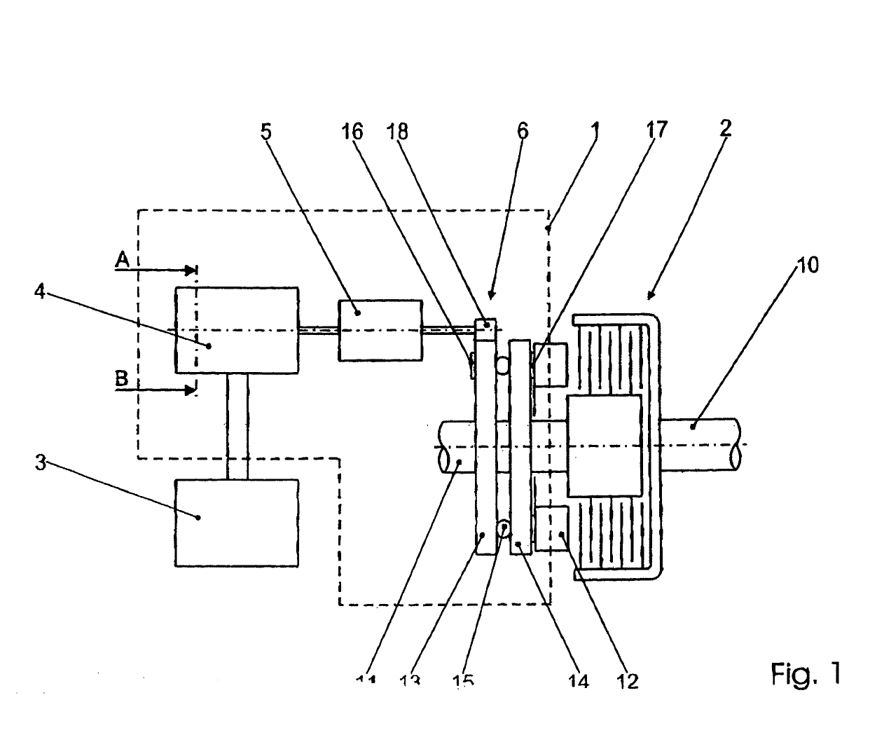

In FIG. 1, the actuator is denoted by way of summary by 1 and the clutch by 2. The actuator comprises an actuating motor 4, which is driven by a control device 3, a transmission mechanism 5 and an actuating element 6, by means of which a specific contact-pressure force or a specific torque to be transmitted is set at the clutch 2. The torque to be transmitted by the clutch 2 is determined by the control device 3 from variables relating to the dynamics of vehicle movement or other variables and is set correspondingly via the current supply to the actuating motor 4.

The clutch 2 itself, a multiple-disk clutch, is only illustrated schematically, as it is of conventional design. It comprises a primary part 10 having a primary shaft and primary disks and a secondary part 11 having a secondary part and secondary disks. The disks of the two parts 10, 11 can be pressed together by means of a contact-pressure plate 12, which is acted upon by an actuating element 6. The actuating element 6 comprises a first ramp ring 13 and a second ramp ring 14 having balls 15 located therebetween. 16, 17 indicate thrust bearings, which support the ramp rings with respect to parts which are not rotating or are rotating at another speed.

Such actuating elements are likewise known per se and are generally available. One of the two ramp rings, in this case the ring 13, is set in rotation by a pinion 18, which forms the output drive of the gear mechanism 5. The gear mechanism 5 is a reduction gear, for example a spur gear or a harmonic drive or a worm gear, which does not need to be self-locking thanks to the invention. Within the scope of the invention, other transmission mechanisms and other actuating elements can also be used; the invention is not restricted to the exemplary embodiment illustrated. For example, the two ramps rings 13, 14 could be actuated via a torsion cam and scissor-action lever (neither is illustrated). In place of the ramp rings, other mechanisms may moreover also be used.

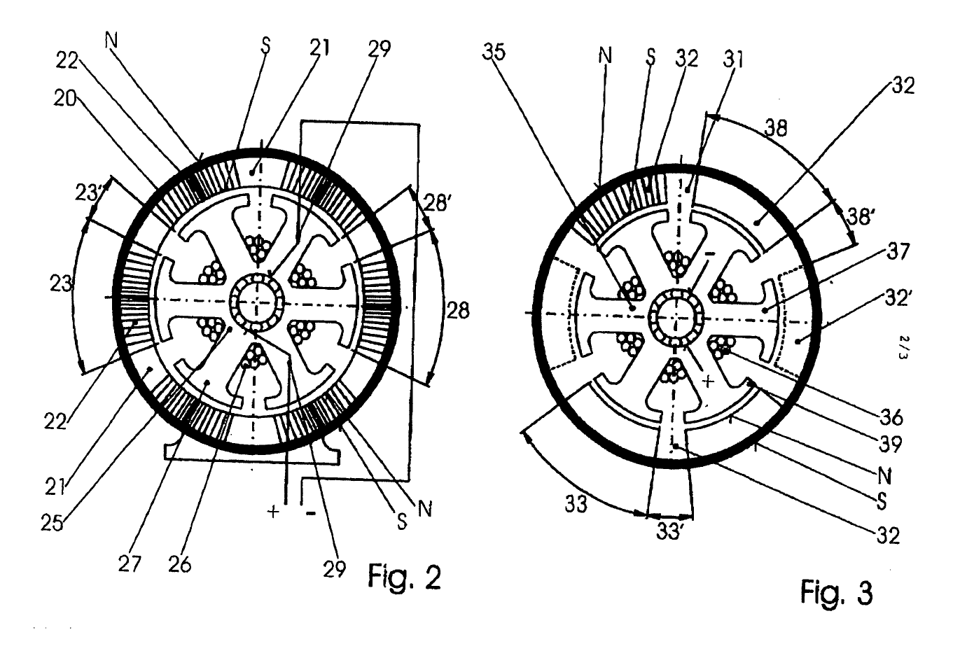

FIG. 2 shows a first embodiment of the actuating motor 4, in detail. It comprises a stator 20 and a rotor 25. The stator 20 is in this case designed as a permanent magnet in the form of a completely closed hollow cylinder, on which first zones having a low magnetic field strength 21 alternate with second zones having a high magnetic field strength 22. Their polarization is indicated by the letters N and S in the drawing. The first zones 21 of the stator 20 in each case cover a circumferential angle 23, and the second zones, lying therebetween, cover a circumferential angle 23′. The rotor 25 in this case has six pole teeth 27 having a winding 26. The shape of the pole teeth 27 is described in more detail with reference to FIG. 3. The circumferential angle of the pole teeth 27 is denoted by 28, and that of the interspaces between the pole teeth is denoted by 28′. Since it is a DC motor, the current supply to the rotor 25 takes place via a commutator 29.

The embodiment shown in FIG. 3 differs from the preceding embodiment only in terms of the design of the stator; the rest is as described with reference to FIG. 2. In this case, the stator 30 is equipped with two pairs of permanent magnets 31, whose polarization is illustrated. However, it is also possible for a further pair 31′, indicated by dashed lines, to be provided. Interspaces 32 are between the permanent magnets 31. The circumferential angle of the permanent magnets 31 is denoted by 33, and the circumferential angle of the interspaces 32 is denoted by 33′. The rotor 35 having the winding 36 and the pole teeth 37 is as is illustrated in FIG. 2. The circumferential angle of the pole teeth 37 is denoted by 38, and that of the interspaces 32 is denoted by 38′. The tips 39 of the pole teeth, that is the ends adjoining the interspaces between the poles, are as thin as possible in the radial direction.

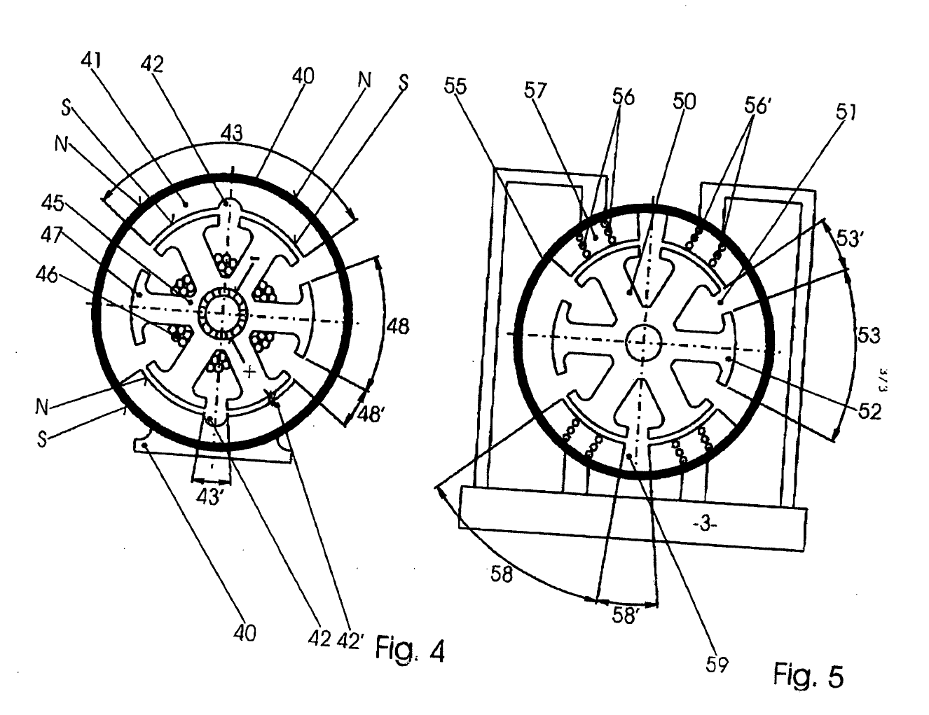

The embodiment shown in FIG. 4 differs from that shown in FIG. 3 only by the fact that a single permanent magnet 40 with a slot 42 is provided in place of two permanent magnets 31 with the interspace 32. These slots 42 are one possibility for creating a zone having an increased gap width. The gap is in this case understood to be the air gap denoted by 42′, which, when viewed from a pole tooth of the rotating rotor, becomes larger when passing the slots 42. All remaining features are the same, and the reference symbols are those as in FIG. 3, but increased by 10.

In the embodiment shown in FIG. 5, the relationships are reversed. In this case, it is not the stator but the rotor 50 which forms the first part of the motor with the permanent magnet (s). The first zones having a low magnetic field strength 51 and the second zones having a high magnetic field strength 52 are in this case formed on the rotor 50. In this regard, there are again the possibilities described with reference to the preceding figures; only those corresponding to FIG. 3 are illustrated. These zones 51, 52 assume a circumferential angle 53, 53′. In this case, it is therefore the stator 55 which accommodates the winding 56 and has the pole shoe 57 (corresponding to the pole teeth of the preceding exemplary embodiments). The circumferential angles of the pole shoes 57 and the interspaces 59 are denoted by 58 and 58′, respectively. As a result of the fact that the windings 56 are in the stator and are therefore not fed via a “mechanical commutator”, the field current is fed in already commutated form to the windings 56, 56′ and further windings which may be present. This “electronic commutation” takes place in the control device 3. In this case, the control device 3 is only intended by way of summary; it may combine various functions within it.

Overall, the described arrangements achieve a situation in which the currentless actuating motor remains in the position illustrated in FIGS. 2 to 5 and is fixed there only by the action of the permanent magnets against a certain force. Since in all of the exemplary embodiments of the actuating motor shown there is trigonal symmetry, precisely six different positions correspond to the position illustrated.

1-11. (canceled)

12. Actuator comprising an electric actuating motor, a transmission mechanism and an actuating element, wherein the actuating element is brought into a specific position by the actuating motor and to be held in said position, and the actuating motor being a DC motor which comprises a first part with a number of permanent magnets distributed over the circumference and a second part which has pole teeth having windings, which are fed with commutated current, wherein
a) the first part (20; 30; 40; 50) has alternately first zones having a low magnetic field strength (21; 31; 41; 51) and second zones having a high magnetic field strength (22; 32; 24; 52) over its circumference, the circumferential angle (23; 33; 34; 35) of the second zones (22; 32; 24; 52) being equal to the circumferential angle (28; 38; 48; 58) of the pole teeth (27; 37; 47; 57) of the second part (25; 35; 45; 55),
b) the number of pole teeth (27; 37; 47; 57) distributed evenly over the circumference being selected such that all of the second zones (22; 32; 24; 52) are always passed at the same time by a pole tooth (27; 37; 47; 57),
c) with the result that, in the state in which there is no current flowing, an increased pulsating torque is exerted between the first part (20; 30; 40; 50) and the second part (25; 35; 45; 55).

13. Actuator according to claim 12, wherein the first zones having a low magnetic field strength (21) and the second zones having a high magnetic field strength (22) are produced by the permanent magnet(s) (20) being magnetized variably over the circumference.

14. Actuator according to claim 12, wherein at least some of the first zones having a low magnetic field strength (31) are formed by interspaces between two adjacent permanent magnets (32).

15. Actuator according to claim 12, wherein at least some of the first zones having a low magnetic field strength (41) are created by the air gap (41′) being enlarged in the radial direction in at least individual permanent magnets (42), whose circumferential angle (43) is a multiple of the circumferential angle (48) of the pole teeth (47).

16. Actuator according to claim 12, wherein the circumferential angle (23′; 33′; 43′; 53′) of at least some of the first zones having a low magnetic field strength (21; 31; 41; 51) is approximately equal to the circumferential angle (28′; 38′; 48′, 58′) of the interspaces in the circumferential direction between the pole teeth (27; 37; 47; 57).

17. Actuator according to claim 16, wherein this circumferential angle (23′; 33′; 43′; 53′) is in the range between 0.2 and 0.3 times the circumferential angle (28; 38; 48; 58) of the pole teeth (27; 37; 47; 57).

18. Actuator according to claim 12, wherein the thickness of the tips (39) of the pole teeth (27; 37; 47) in the radial direction is smaller than the distance between the tips of two adjacent pole teeth.

19. Actuator according to claim 12, wherein the first part (20; 30; 40) is the stator, and the second part (25; 35; 45) is the inner rotor.

20. Actuator according to claim 12, wherein the second part (55) is the stator, and the first part (50) is the inner rotor.

21. Controllable friction clutch having an actuator according to one of claims 12 to 20.

22. Controllable friction clutch according to claim 21, wherein the transmission mechanism (5) is a toothed gear, and the actuating element (6) comprises two ramp rings (13, 14) which can be rotated in relation to one another, of which at least one can be rotated via the transmission mechanism (5).
